(19) United States
(12) Patent Application Publication
(10) Pub. No.: US 2023/0373581 A1
(43) Pub. Date: Nov. 23, 2023

(54) Seat Device for a Tilting Vehicle

(71) Applicant: Bayerische Motoren Werke Aktiengesellschaft, Muenchen (DE)

(72) Inventor: Georg KOETZINGER, Bergen (DE)

(21) Appl. No.: 18/030,397

(22) PCT Filed: Oct. 12, 2021
(86) PCT No.: PCT/EP2021/078088

§ 371 Date: Apr. 5, 2023

(30) Foreign Application Priority Data
Nov. 27, 2020 (DE) 10 2020 131 458.2

(51) Int. Cl. B62J 1/12; B62K 11/00; B62J 1/10

(52) U.S. Cl. CPC B62J 1/12; B62K 11/00; B62J 1/10

(57) ABSTRACT

A seat device for a tilting vehicle, in particular a tilting vehicle having a boxer engine, includes: at least one seat; at least one holder by which the seat can be positioned or is positioned on a vehicle component of the tilting vehicle or on a vehicle frame on a side facing the direction of travel and which can restrict movement of the seat parallel to the vertical axis and to the transverse axis; and at least one coupling device which can be attached or is attached on a side of the seat facing away from the direction of travel, by which coupling device the seat can be fixed or is fixed, directly or indirectly, to the vehicle frame so as to be movable to a limited extent. The coupling device includes: at least one first coupler fixed directly or indirectly to the seat; at least one second coupler fixed to the vehicle frame; and at least one first movement clearance device which is located between the first coupler and the second coupler and by which the seat can be moved to a limited extent relative to the vehicle frame, at least in or obliquely to the transverse axis of the tilting vehicle, by movement of the first coupler relative to the second coupler.

### BACKGROUND AND SUMMARY

The invention relates to a seat device for a tilting vehicle, in particular comprising a boxer engine.

In the case of tilting vehicles, the seat devices are fixed to a vehicle component or to a vehicle frame at least on a side facing away from the direction of travel. By this means, the seat device and the vehicle frame, in particular the seat bench, which is connected to the vehicle frame, and the vehicle frame, are coupled to one another in respect of their kinematics.

If the tilting vehicle comprises a boxer engine, the cylinder of the boxer engine can be arranged offset in the longitudinal direction with respect to a central bearing. By means of this offset, the tilting vehicle undergoes angular momentum about the vertical axis of the tilting vehicle. This may give rise to vibrations which can be transmitted to the seat device and which may be perceived to be unpleasant by a user of the tilting vehicle.

It is an object of an exemplary embodiment of the invention to reduce the vibrations occurring in a seat device during the operation of a tilting vehicle.

This object is achieved by a seat device for a tilting vehicle, in particular a tilting vehicle comprising a boxer engine, having at least one seat bench, having at least one holder, by means of which the seat bench can be arranged or is arranged on a vehicle component of the tilting vehicle or on a vehicle frame on a side facing the direction of travel and by means of which movement of the seat bench parallel to the vertical axis and to the transverse axis can be limited, and having at least one coupling unit, which can be fixed or is fixed on a side of the seat bench facing away from the direction of travel, by means of which coupling unit the seat bench can be fixed or is fixed indirectly or directly to the vehicle frame so as to be movable to a limited extent, and which comprises at least one first coupler fixed indirectly or directly to the seat bench, at least one second coupler fixed to the vehicle frame, and at least one first movement clearance device which is arranged between the first coupler and second coupler and by means of which the seat bench is movable to a limited extent relative to the vehicle frame, at least in or transversely to the transverse axis of the tilting vehicle, by means of movement of the first coupler relative to the second coupler.

Owing to the fact that the seat device comprises a coupling unit, with which the seat bench can be fixed indirectly or directly, via a first coupler and a second coupler, to the vehicle frame so as to be movable to a limited extent, and also a movement clearance device which is arranged between the first coupler and second coupler can be fixed indirectly or directly to the vehicle frame so as to be movable to a limited extent, vibrations transmitted to the seat bench from the vehicle frame can be compensated for or damped. This improves the riding sensation for a user of the tilting vehicle.

The coupling unit can be arranged on a lower side of the seat bench facing the vehicle frame.

A tilting vehicle is understood as meaning bicycles, motorbikes or motor vehicles similar to motorbikes, such as motor scooters, in particular two-, three- or four-wheeled motor scooters, scooters, tiltable trikes, quad bikes, or the like.

In one embodiment of the seat device, provision is made that the coupling unit comprises at least one rod- or strip-shaped, flexurally rigid spacer which can be used to fix the seat bench indirectly or directly to the vehicle frame, and which is arranged between the seat bench and the vehicle frame and at the one end of which the first coupler or the second coupler is arranged.

The rod- or strip-shaped, flexurally rigid spacer can be used to fix the seat bench to the vehicle frame at a distance from the vehicle frame. In such a case, the first coupler or the second coupler can be arranged on the rod- or strip-shaped, flexurally rigid spacer.

In a development of the last-mentioned embodiment, it has proven advantageous if the spacer extends in or counter to the direction of travel from the end of the seat bench facing away from the direction of travel.

If the tilting vehicle comprises a boxer engine, in which vibrations arise because of angular momentum about the vertical axis, it may prove advantageous if the coupling unit is shifted in the direction of the center of the tilting vehicle. In such a case, the vibrations which can be transmitted from the vehicle frame in the direction of the seat bench are reduced because of the smaller centrifugal forces that prevail.

In order to fix the spacer, it has proven advantageous if the coupling unit comprises at least one fastener, by means of which the spacer can be fixed or is fixed to the seat bench or to the vehicle frame on a side of the spacer opposite the first movement clearance device.

In such a case, the spacer can be fixed by the at least one fastener either to the seat bench or to the vehicle frame. In a corresponding manner, the first coupler, the second coupler and the movement clearance device are arranged at the end of the spacer opposite the at least one fastener and are thereby fixed to the vehicle frame and/or to the seat bench.

In order to further improve cushioning or damping of vibrations transmitted from the vehicle frame to the seat bench, provision is made, in a development of the last-mentioned embodiment, that the coupling unit comprises at least one second movement clearance device which can be arranged or is arranged between the fastener and a mounting of the seat bench or a mounting of the vehicle frame, and by means of which the seat bench is movable to a limited extent relative to the vehicle frame, at least in or transversely to the transverse axis of the tilting vehicle, by means of movement of the fastener relative to the mounting.

In order to further restrict a possibility of movement of the seat bench with respect to the vehicle frame, it has proven advantageous if the coupling unit comprises at least two spaced-apart fastener, by means of which the spacer can be fixed or is fixed to the seat bench or to the vehicle frame, and at least two second movement clearance device, one second movement clearance device being assigned to one fastener each.

By providing at least two spaced-apart fastener, movement of the seat bench is prevented by the at least one fastener having a radius of the length of the spacer.

The first movement clearance device and/or the second movement clearance device can basically be designed as desired if they comply with the technical function of permitting a limited movement of the first coupler relative to the second coupler and/or the fastener. The first movement clearance device and/or the second movement clearance device can be realized in a technically simple way if the first movement clearance device and/or the second movement clearance device comprises/comprise a damping means, in particular an elastic grommet, an elastically deformable or dimensionally stable bushing and/or a step pin.

In order to further reduce transmission of vibrations from the vehicle frame or a vehicle component in the direction of the seat bench of the seat device, an exemplary embodiment of the seat device comprises a damping unit which comprises at least one damping element which can be arranged or is arranged on the seat bench and/or on the vehicle frame or a vehicle component, can be positioned with its free end touching the vehicle frame or the vehicle component and/or the seat bench, and by means of which a force acting along the vertical axis can be damped.

Vibrations acting in the direction of the vertical axis can be damped by the at least one damping element. Furthermore, the seat bench or the vehicle frame, and/or the vehicle component, can be moved relative to at least one damping element. The damping element lies touching the vehicle frame or the vehicle component, when the damping element is fixed to the seat bench, as a result of which a sliding movement of the vehicle frame or of the vehicle component relative to the damping element is permitted. Conversely, the seat bench is movable relative to the damping element if the damping element is fixed to the vehicle frame or to a vehicle component.

In order to further improve the damping action, provision is made in a development of the last-mentioned embodiment that the at least one damping element of the damping unit comprises at least two portions which extend in lamellar form in the direction of the vertical axis and are spaced apart from one another by a gap.

This makes it possible for small vibrations to be absorbed by the at least one damping element without the seat bench, and/or the vehicle frame or the vehicle component carrying out a movement relative to the damping element. Furthermore, in such a case, the service life of the damping element is improved.

Furthermore, in one embodiment of the seat device, provision is made that the holder, by means of which the seat bench can be arranged or is arranged on a vehicle component of the motor vehicle or on a vehicle frame on a side facing the direction of travel, is designed in the manner of a hook or eyelet in which the seat bench can be arranged so as to engage therein with an eyelet or a hook formed in a corresponding, in particular complementary manner.

In such a case, the seat bench can be arranged on the holder in a simple manner and is released counter to the direction of travel only for removal purposes. The seat bench is fixed against the holder when the seat bench is fixed to the vehicle frame via the coupling unit.

Further features, details and advantages of the invention emerge from the attached patent claims, from the graphical illustration and description below of a preferred embodiment of the seat device.

### BRIEF DESCRIPTION OF THE DRAWINGS

FIG. 1 shows an opened-up top view of the lower side of a seat bench of a seat device and an upper side of a vehicle frame of a tilting vehicle;

FIG. 2 is a perspective side view of a first exemplary embodiment of a spacer of the coupling unit of the seat device; and

FIG. 3 is a perspective side view of a second exemplary embodiment of a spacer of the coupling unit of the seat device.

### DETAILED DESCRIPTION OF THE DRAWINGS

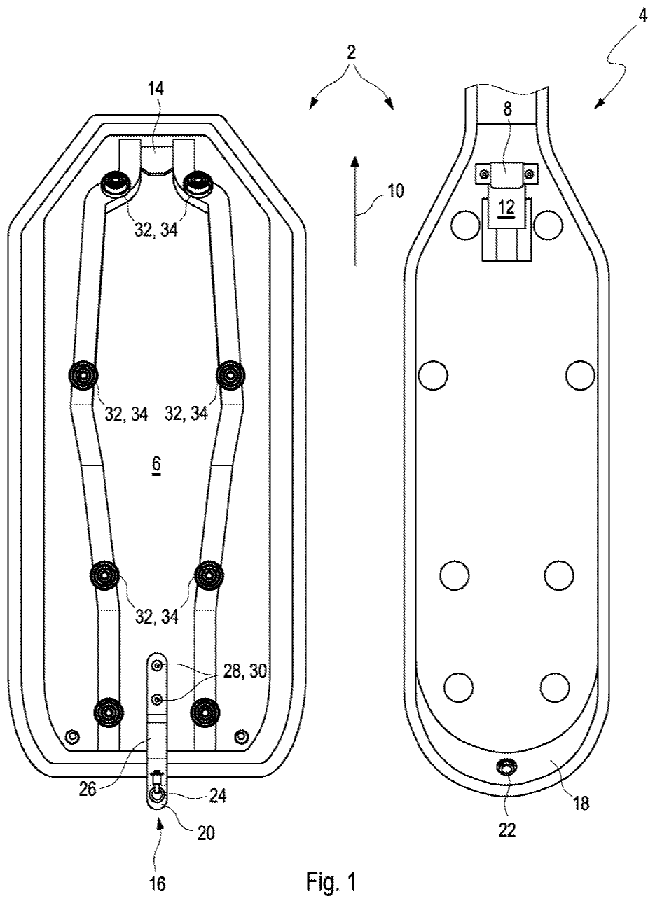

FIG. 1 shows a seat device, provided overall with the reference sign 2, for at least one tilting vehicle 4 (only partially illustrated in the figures) comprising a boxer engine (not explicitly illustrated in the figures). The seat device 2 comprises a seat bench 6 which is illustrated in FIG. 1 in a top view of the side facing the tilting vehicle. The seat device 2 comprises a holder 8, by means of which the seat bench 6 is fixed to a vehicle component 12 of the tilting vehicle 4 on a side facing the direction of travel 10. In the exemplary embodiment shown in FIG. 1, the holder 8 is designed in the manner of an eyelet, in which the seat bench 6 can be arranged so as to engage therein with a hook 14 formed in a corresponding, in particular complementary, manner.

Furthermore, the seat device 2 comprises a coupling unit 16 which can be fixed or is fixed to a side of the seat bench 6 facing away from the direction of travel 10. The seat bench 6 can be fixed to a vehicle frame 18 by the coupling unit 16. For this purpose, the coupling unit 16 comprises a first coupler 20, which is fixed indirectly to the seat bench 6, and a second coupler 22, which is fixed to the vehicle frame 18. In order to ensure a limited movement of the first coupler 20 relative to the second coupler 22, the coupling unit 16 comprises a first movement clearance device 24, by means of which the seat bench 6 is movable to a limited extent relative to the vehicle frame 18, at least in or transversely to the transverse axis of the tilting vehicle 4, by means of movement of the first coupler 20 relative to the second coupler 22.

In the case of the exemplary embodiment shown in the figures, the coupling unit 16 comprises a rod- or strip-shaped, flexurally rigid spacer 26 which can be used to couple the seat bench 6 to the vehicle frame 18. In the exemplary embodiments shown in the figures, the spacer 26 comprises the first coupler 20 and the movement clearance device 24 on its side facing away from the direction of travel 10.

Furthermore, it can be seen in the figures that the spacer 26 is fixed to the seat bench 6 by two fastener 28. A second movement clearance device 30 is arranged on each of the fastener 28, the second movement clearance device being arranged between the fastener 28 and a mounting of the seat bench 6 and by means of which the seat bench 6 is movable to a limited extent relative to the vehicle frame 18, at least in or transversely to the transverse axis of the tilting vehicle 4, by means of movement of the fastener 28 relative to the mounting.

Furthermore, the seat device 2 comprises a damping unit 32 which, in the exemplary embodiments shown in the figures, comprises a plurality of damping elements 34. In the exemplary embodiments illustrated in FIGS. 1 to 3, the damping elements are fixed on that side of the seat bench 6 which faces the vehicle frame 18. In an arrangement of the seat bench 6, the damping elements 34 of the damping unit 32 lie on the vehicle frame 18, and/or on the vehicle component 12.

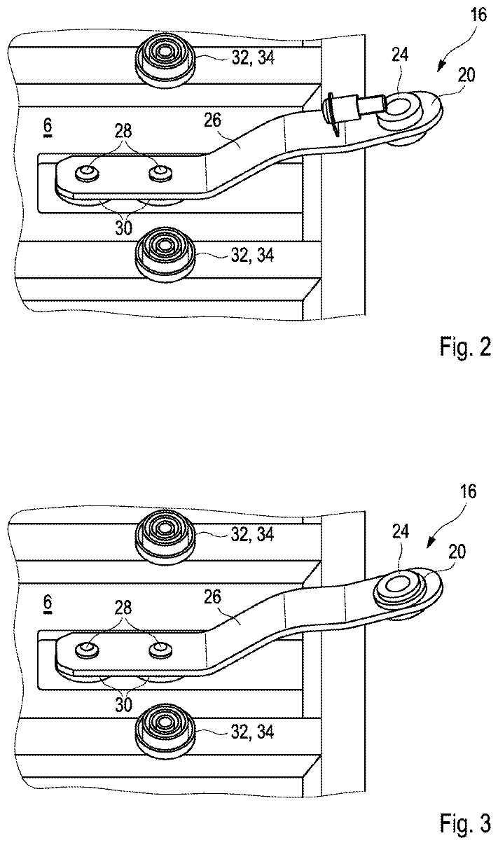

FIG. 2 shows a first exemplary embodiment of the seat device 2 in which the coupling unit 16 comprises a first movement clearance device 24 which is formed by an elastic grommet. The use of a rubber grommet as first movement clearance device 24 ensures movement of the first coupler 20 with respect to the second coupler 22 and at the same time permits damping of vibrations because of the elastic deformability of the rubber grommet.

FIG. 3 shows a second exemplary embodiment of the seat device 2 in which the first movement clearance device 24 of the coupling unit 16 is formed by a bushing. A fixing element, such as a screw or pin, can be guided in the bushing, and the bushing per se is movable to a limited extent between the first coupler 20 and the second coupler 22.

The features of the invention disclosed in the above description, in the claims and in the drawing may be essential both individually and also in any desired combination for realizing the invention in its various embodiments.

### LIST OF REFERENCE SIGNS

2 Seat device
4 Tilting vehicle
6 Seat bench
8 Holder
10 Direction of travel
12 Vehicle component
14 Hook
16 Coupling unit
18 Vehicle frame
20 First coupler
22 Second coupler
24 First movement clearance device
26 Spacer
28 Fastener
30 Second movement clearance device
32 Damping unit
34 Damping element

1.-10. (canceled)

11. A seat device for a tilting vehicle, comprising:
a seat bench having at least one holder, by which the seat bench is arrangable or is arranged on a vehicle component of the tilting vehicle or on a vehicle frame, on a side facing a direction of travel and by which movement of the seat bench parallel to a vertical axis and to a transverse axis is limited;
at least one coupling unit which is fixable or is fixed on a side of the seat bench facing away from the direction of travel, by which coupling unit the seat bench is fixable or is fixed indirectly or directly to the vehicle frame so as to be movable to a limited extent, wherein
the coupling unit comprises at least one first coupler fixed indirectly or directly to the seat bench, at least one second coupler fixed to the vehicle frame, and at least one first movement clearance device which is arranged between the first coupler and second coupler and by which the seat bench is movable to a limited extent relative to the vehicle frame, at least in or obliquely to the transverse axis of the tilting vehicle, by movement of the first coupler relative to the second coupler.

12. The seat device according to claim 11, wherein
the coupling unit further comprises:
at least one rod- or strip-shaped, flexurally rigid, spacer which is used to fix the seat bench indirectly or directly to the vehicle frame, and which is arranged between the seat bench and the vehicle frame and, at one end of which, the first coupler or the second coupler is arranged.

13. The seat device according to claim 12, wherein
the spacer extends in or counter to the direction of travel from an end of the seat bench facing away from the direction of travel.

14. The seat device according to claim 12, wherein
the coupling unit further comprises:
at least one fastener, by which the spacer is fixable or is fixed to the seat bench or to the vehicle frame on a side of the spacer opposite the first movement clearance device.

15. The seat device according to claim 14, wherein
the coupling unit further comprises:
at least one second movement clearance device which is arrangeable or is arranged between the fastener and a mounting of the seat bench or a mounting of the vehicle frame, and by which the seat bench is movable to a limited extent relative to the vehicle frame, at least in or obliquely to the transverse axis of the tilting vehicle, by movement of the fastener relative to the mounting.

16. The seat device according to claim 15, wherein
the coupling unit further comprises:
at least two spaced-apart fasteners by which the spacer is fixable or is fixed to the seat bench or to the vehicle frame, and
at least two second movement clearance devices, a respective movement clearance device being assigned to each fastener.

17. The seat device according to claim 14, wherein
the first movement clearance device comprises a damper.

18. The seat device according to claim 17, wherein
the damper is an elastic grommet, an elastically deformable or dimensionally stable bushing, and/or a step pin.

19. The seat device according to claim 15, wherein
the first movement clearance device and/or the second movement clearance device comprises a damper.

20. The seat device according to claim 19, wherein
the damper is an elastic grommet, an elastically deformable or dimensionally stable bushing, and/or a step pin.

21. The seat device according to claim 11, further comprising:
a damping unit comprising at least one damping element which is arrangeable or is arranged on the seat bench and/or on the vehicle frame or a vehicle component, is positionable with its free end touching the vehicle frame or the vehicle component and/or the seat bench, and by which a force acting along the vertical axis is damped.

22. The seat device according to claim 21, wherein
the at least one damping element of the damping unit comprises at least two portions which extend in lamellar form in the direction of the vertical axis and are spaced apart from one another by a gap.

23. The seat device according to claim 11, wherein
the holder by which the seat bench is arrangeable or is arranged on a vehicle component of the motor vehicle or on a vehicle frame on a side facing the direction of travel, is configured as a hook or eyelet and in which the seat bench is arrangable so as to engage therein with an eyelet or a hook formed in a corresponding manner.

24. A tilting vehicle, comprising:
a boxer engine; and
the seat device according to claim 11.
